(19) United States
(12) Patent Application Publication
(10) Pub. No.: US 2026/0032763 A1
(43) Pub. Date: Jan. 29, 2026

(54) COMMUNICATION METHOD, USER EQUIPMENT, NON-TRANSITORY COMPUTER-READABLE MEDIUM, CHIPSET AND SYSTEM

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 19/349,639

(22) Filed: Oct. 3, 2025

Related U.S. Application Data
(63) Continuation of application No. PCT/JP2024/013444, filed on Apr. 1, 2024.
(60) Provisional application No. 63/494,067, filed on Apr. 4, 2023.

(51) Int. Cl. H04W 76/27; H04W 76/40

(52) U.S. Cl. CPC H04W 76/27; H04W 76/40

(57) ABSTRACT

A communication method performed by a user equipment in a mobile communication system that provides a multicast/broadcast service (MBS) includes receiving a multicast session from a network in a radio resource control (RRC) connected state using a first multicast radio bearer (MRB) for the RRC connected state, receiving, from the network, an RRC release message for causing the user equipment to transition to an RRC inactive state, the RRC release message including configuration information indicating a configuration of a second MRB used for reception of the multicast session in the RRC inactive state, and establishing the second MRB by applying the configuration information before suspending the first MRB in response to the reception of the RRC release message.

### RELATED APPLICATIONS

The present application is a continuation based on PCT Application No. PCT/JP2024/013444, filed on Apr. 1, 2024, which claims the benefit of U.S. Provisional Patent Application No. 63/494,067 filed on Apr. 4, 2023. The content of which is incorporated by reference herein in their entirety.

### TECHNICAL FIELD

The present disclosure relates to a communication method, user equipment, non-transitory computer-readable medium, chipset and system used in a mobile communication system.

### BACKGROUND

The 3rd Generation Partnership Project (3GPP) has defined the technical specifications of New Radio (NR) that is a radio access technology of the fifth generation (5G). NR has features such as high speed, large capacity, high reliability, and low latency as compared to Long Term Evolution (LTE) that is a radio access technology of the fourth generation (4G). The 3GPP has defined technical specifications of multicast/broadcast services (MBS) of 5G/NR.

In 3GPP Release 17, MBS multicast reception (i.e., multicast reception) is possible only for a user equipment in a radio resource control (RRC) connected state (see, for example, Non-Patent Document 1). On the other hand, in 3GPP Release 18, technical specifications are scheduled to be extended so that a user equipment in an RRC inactive state can perform multicast reception.

### CITATION LIST

### Non-Patent Literature

Non-Patent Document 1: 3GPP Technical Specification: TS 38.300 V17.3.0

### SUMMARY

A communication method according to a first aspect is a communication method performed by a user equipment in a mobile communication system that provides a multicast/broadcast service (MBS). The communication method includes receiving, from a network, a radio resource control (RRC) release message for causing the user equipment to transition to an RRC inactive state, the RRC release message including configuration information that comprises a point-to-multipoint (PTM) configuration used in reception of a multicast session in the RRC inactive state; and receiving the multicast session in the RRC inactive state based on the RRC release message including the configuration information.

A communication method according to a second aspect is a method performed by a user equipment in a mobile communication system that provides a multicast/broadcast service (MBS). The communication method includes receiving a multicast session from a network in a radio resource control (RRC) connected state using a first multicast radio bearer (MRB) for the RRC connected state, receiving, from the network, an RRC release message for causing the user equipment to transition to an RRC inactive state, the RRC release message including configuration information indicating a configuration of a second MRB used for reception of the multicast session in the RRC inactive state, and establishing the second MRB by applying the configuration information before suspending the first MRB in response to the reception of the RRC release message.

A user equipment according to a third aspect is a device used in a mobile communication system that provides a multicast/broadcast service (MBS). The user equipment includes a controller configured to perform processing of receiving a multicast session from a network in a radio resource control (RRC) connected state using a first multicast radio bearer (MRB) for the RRC connected state, processing of receiving, from the network, an RRC release message for causing the user equipment to transition to an RRC inactive state, the RRC release message including configuration information indicating a configuration of a second MRB used for reception of the multicast session in the RRC inactive state, and processing of establishing the second MRB by applying the configuration information before suspending the first MRB in response to the reception of the RRC release message.

### BRIEF DESCRIPTION OF THE DRAWINGS

FIG. 1 is a diagram illustrating a configuration example of a mobile communication system according to an embodiment.

FIG. 2 is a diagram illustrating a configuration example of a user equipment (UE) according to an embodiment.

FIG. 3 is a diagram illustrating a configuration example of a base station (gNB) according to an embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIG. 6 is a flowchart illustrating an overview of an operation of the UE according to an embodiment.

FIG. 7 is a flowchart illustrating an example of the sequence of an operation of the mobile communication system according to an embodiment.

FIG. 8 is a diagram illustrating specification modification example 1 according to an embodiment.

FIG. 9 is a diagram illustrating specification modification example 2 according to an embodiment.

FIG. 10A is a diagram illustrating an initial configuration procedure for an ongoing session.

FIG. 10B is a diagram illustrating an initial configuration procedure for a suspended session.

### DESCRIPTION OF EMBODIMENTS

A mobile communication system according to an embodiment is described with reference to the drawings. In the description of the drawings, the same or similar parts are denoted by the same or similar reference signs.

### (1) System Configuration Example

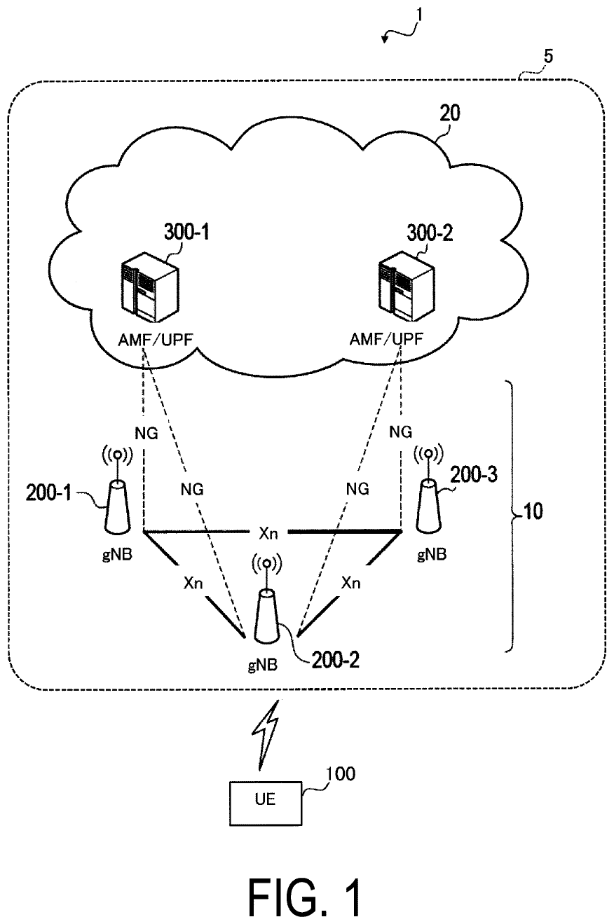

FIG. 1 is a diagram illustrating a configuration example of a mobile communication system 1 according to an embodiment. The mobile communication system 1 complies with the 5^{th}

Generation System (5GS) of the 3GPP standard. The description below takes the 5GS as an example, but Long Term Evolution (LTE) system may be at least partially applied to the mobile communication system. Alternatively, a sixth generation (6G) system may be at least partially applied to the mobile communication system.

The mobile communication system 1 includes User Equipment (UE) 100, a 5G radio access network (Next Generation Radio Access Network (NG-RAN)) 10, and a 5G Core Network (5GC) 20. Hereinafter, the NG-RAN 10 may be simply referred to as a RAN 10. The 5GC 20 may be simply referred to as a core network (CN) 20. The RAN 10 and the CN 20 constitute a network of the mobile communication system 1.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter, simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility control and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

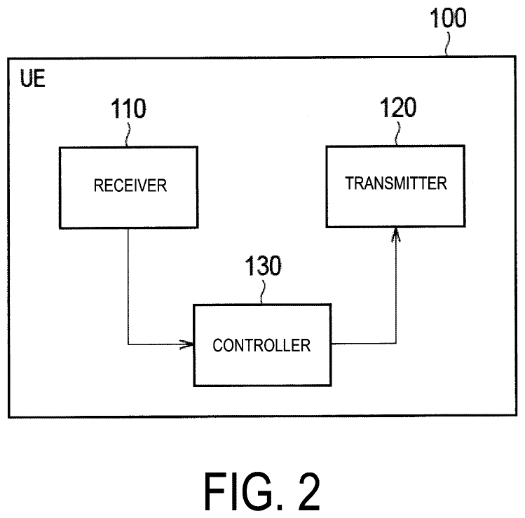

FIG. 2 is a diagram illustrating a configuration example of the user equipment (UE) 100 according to an embodiment. The UE 100 includes a receiver 110, a transmitter 120, and a controller 130. The receiver 110 and the transmitter 120 constitute a wireless communicator that performs wireless communication with the gNBs 200.

The receiver 110 performs various type of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal from the antenna.

The controller 130 performs various types of control and processing in the UE 100. Such processing includes processing of respective layers to be described below. The operations of the UE 100 described above and below may be operations under control of a controller 230. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

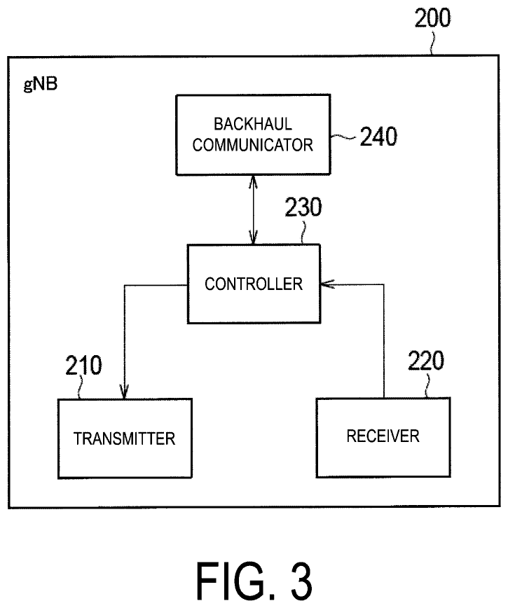

FIG. 3 is a diagram illustrating a configuration example of a gNB 200 (base station) according to an embodiment. The gNB 200 includes a transmitter 210, a receiver 220, the controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal from the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of respective layers to be described below. The operations of the gNB 200 described above and below may also be those performed under control of the controller 230. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via an Xn interface which is an inter-base station interface. The backhaul communicator 240 is connected to the AMF/UPF 300 via an NG interface that is a base station-core network interface. Note that the gNB 200 may include a Central Unit (CU) and a Distributed Unit (DU) (i.e., functions are divided), and both units may be connected via an Fl interface that is a fronthaul interface.

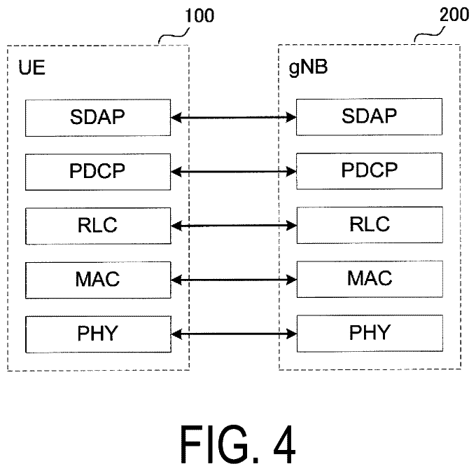

FIG. 4 is a diagram illustrating a configuration of a protocol stack of a radio interface of a user plane handling data.

A radio interface protocol of the user plane includes a PHYsical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs encoding/decoding, modulation/demodulation, antenna mapping/demapping, and resource mapping/demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 performs blind decoding of the PDCCH by using a radio network temporary identifier (RNTI) and acquires a successfully decoded DCI as a DCI addressed to the UE. Cyclic Redundancy Code (CRC) parity bits that are scrambled with the RNTI are added to the DCI transmitted from the gNB 200.

The MAC layer performs priority control of data, retransmission processing through Hybrid Automatic Repeat reQuest (Hybrid ARQ or HARQ), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in uplink and resource blocks to be allocated to the UE 100.

The RLC layer transmits data to the RLC layer on the receiving side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QOS) control performed by the core network and a radio bearer as the unit of QoS control performed by an Access Stratum (AS). Note that, when the RAN is connected to the EPC, the SDAP need not be provided.

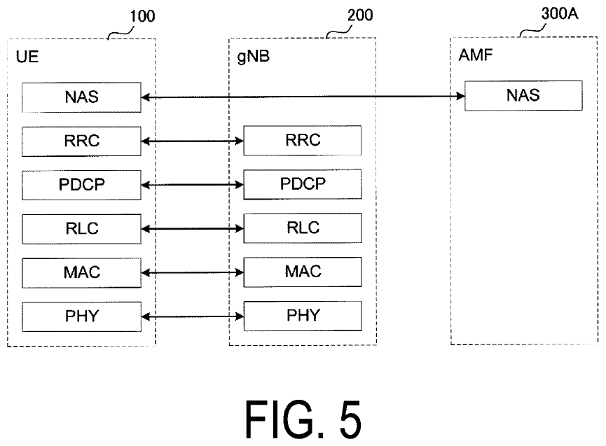

FIG. 5 is a diagram illustrating a configuration of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When connection (RRC connection) is established between RRC of the UE 100 and RRC of the gNB 200, the UE 100 is in an RRC connected state. When connection (RRC connection) is not established between the RRC of the UE 100 and the RRC of the gNB 200, the UE 100 is in an RRC idle state. When the connection between the RRC of the UE 100 and the RRC of the gNB 200 is suspended, the UE 100 is in an RRC inactive state.

The NAS layer (also simply referred to as “NAS”), which is located above the RRC layer, performs session management, mobility management, and the like. NAS signaling is transmitted between the NAS layer of the UE 100 and the NAS layer of an AMF 300A. Note that the UE 100 includes an application layer other than the protocol of the radio interface. The layer below the NAS layer is referred to as an AS layer (also simply referred to as “AS”).

### (2) Overview of MBS

The mobile communication system I can perform delivery with high resource efficiency by using the multicast/broadcast service (MBS).

### (2.1) MBS Broadcast

In broadcast communication services (also referred to as “MBS broadcast”), the same service and the same specific content data are provided simultaneously to every UE 100 in a geographic area. That is, every UE 100 in the broadcast service area is permitted to receive data. The broadcast communication services are delivered to the UE 100 using a broadcast session that is a type of an MBS session. The UE 100 can receive broadcast sessions in any state of the RRC idle state, the RRC inactive state, and the RRC connected state.

Point-to-Multipoint (PTM) delivery is applied to the broadcast communication services. On the other hand, for PTM transmission, the gNB 200 delivers a single copy of an MBS packet to a set (group) composed of a plurality of UEs 100. For example, the gNB 200 schedules a group-common PDSCH scrambled with the G-RNTI by using a group-common PDCCH with a CRC scrambled with a group RNTI (G-RNTI) that is a group-common RNTI.

For a broadcast communication service, the UE 100 receives a broadcast session in the following procedure. First, the UE 100 receives system information block type 20 (SIB 20) from the gNB 200. The SIB 20 includes the configuration of a multicast control channel (MCCH), which is a type of logical channel. Second, the UE 100 receives the MCCH from the gNB 200 based on SIB 20. The MCCH includes a PTM configuration. The PTM configuration transmits a configuration for a Multicast Traffic Channel (MTCH), which is a type of a logical channel and a configuration of a broadcast Multicast Radio Bearer (MRB), which is an MRB for broadcast sessions. The information transmitted by the MCCH may be referred to as MBS broadcast control information. Third, the UE 100 receives the MTCH based on the MCCH. The MTCH transmits a broadcast session (specifically, MBS data belonging to a broadcast session).

Note that the MCCH is a PTM downlink channel for transmitting MBS broadcast control information associated with one or more MTCHs from the network 10 to the UE 100. The MTCH is a PTM downlink channel for transmitting MBS data of a multicast session and/or a broadcast session from the network 10 to the UE 100.

### (2.2) MBS Multicast

In multicast communication services (also referred to as “MBS multicast”), the same service and the same specific content data are simultaneously provided to a specific UE set. That is, not every UE 100 in the multicast service area is permitted to receive data. The multicast communication services are delivered to the UE 100 using a multicast session that is a type of an MBS session.

The UE 100 can receive a corresponding multicast session only after joining the multicast session (session join). The joining the multicast session may mean that the UE 100 is registered in the network 5 (CN 20) as being capable of receiving the multicast session.

For a multicast communication service, in 3GPP Release 17, only a UE 100 in an RRC connected state can receive a multicast session. On the other hand, 3GPP Release 18 is planned to expand such that a UE 100 in the RRC inactive state also can receive a multicast session.

### (2.2.1) Multicast Reception in RRC Connected State

The UE 100 in the RRC connected state can receive a multicast session (specifically, MBS data belonging to the multicast session) using a mechanism such as Point-to-Point (PTP) and/or Point-to-Multipoint (PTM) delivery.

For a multicast communication service, the UE 100 in the RRC connected state receives a multicast session in the following procedure. First, the UE 100 receives an RRC Reconfiguration message from the gNB 200. The RRC Reconfiguration message is a message transmitted on a Dedicated Control CHannel (DCCH). The RRC Reconfiguration message transmits a configuration related to an MTCH for receiving the multicast session and a configuration of a multicast MRB which is an MRB for the multicast session. Second, the UE 100 receives the MTCH based on the RRC Reconfiguration message. The MTCH transmits the multicast session (specifically, MBS data belonging to the multicast session). The configuration related to the MTCH (MTCH configuration), the MTCH configuration, is a configuration related to MTCH reception, and includes, for example, at least one selected from the group consisting of a group identifier (G-RNTI), a discontinuous reception configuration (DRX configuration or scheduling information: MTCH transmission ON time, MTCH transmission cycle, reference time and time offset, HARQ retransmission configuration), a layer 2 configuration (PDCP configuration or RLC configuration), and a physical channel configuration (PDCCH configuration, PDSCH configuration, SSB mapping configuration).

### (2.2.2) Multicast Reception in RRC Inactive State

The UE 100 in the RRC inactive state can receive the multicast session (particularly, the MBS data belonging to the multicast session) by using the mechanism for PTM delivery.

For a multicast communication service, the UE 100 in the RRC inactive state can receive a multicast session in the following procedure. First, the UE 100 in the RRC inactive state receives a newly introduced system information block (also referred to as a “new SIB”) from the gNB 200. The new SIB includes the configuration of a newly introduced MCCH (also referred to as a “multicast MCCH”). Second, the UE 100 in the RRC inactive state receives, from the gNB 200, the multicast MCCH based on the new SIB. The multicast MCCH includes a PTM configuration. The PTM configuration transmits a configuration related to an MTCH for receiving the multicast session and a configuration of a multicast MRB which is an MRB for the multicast session. Third the UE 100 in the RRC inactive state receives the MTCH based on the multicast MCCH. The MTCH transmits the multicast session (specifically, MBS data belonging to the multicast session).

When the gNB 200 configures the UE 100 to receive multicast in the RRC inactive state, the gNB can transmit the PTM configuration to the UE 100 using an RRC release message including a suspend configuration. In this case, when the RRC Release message including the PTM configuration is received from the gNB 200, the UE 100 transitions to the RRC inactive state and receives a multicast session in the RRC inactive state.

### (3) System Operation Example

Hereinafter, an operation related to multicast reception in the RRC inactive state will be described.

When a multicast session is activated, that is, when a multicast session is in progress, the UE 100 in the RRC connected state is configured with the multicast MRB for multicast reception by an RRC Reconfiguration message and can start receiving the MTCH.

In multicast reception in the RRC inactive state, an MRB for multicast reception (also referred to as a “multicast inactive MRB”) may be configured in the UE 100 of the RRC connected state with an RRC Release message.

When the UE 100 in the RRC connected state receives the RRC Release message including the suspend configuration (suspendConfig), the UE suspends the multicast MRB for the RRC connected state. If the RRC Release message includes the PTM configuration for the RRC inactive state, the UE 100 continues to receive the same multicast session.

Service continuity of the multicast session needs to be ensured during/after transition of the RRC state. Therefore, the UE 100 needs to apply the PTM configuration of a multicast inactive MRB before temporarily suspending the multicast MRB. The UE 100 starts receiving the multicast inactive MRB as soon as the PTM configuration is applied. This can keep multicast reception from being interrupted when the UE transitions from the RRC connected state to the RRC inactive state.

### (3.1) Overview of Operation of UE

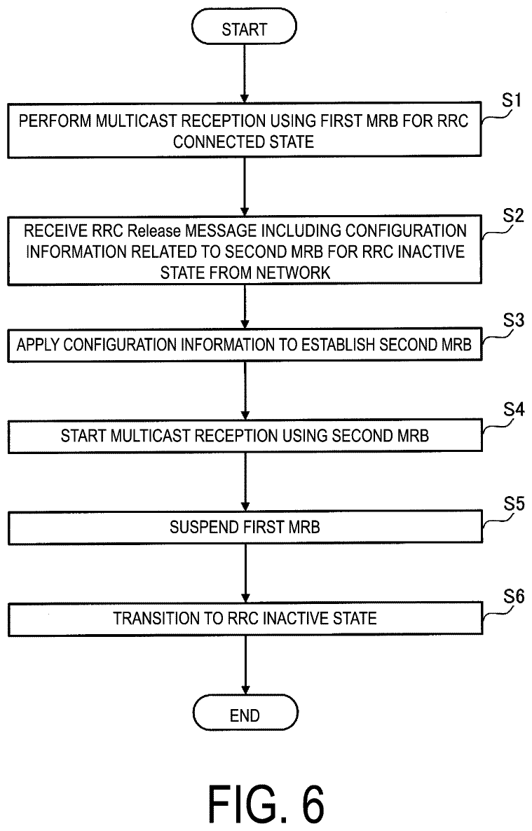

FIG. 6 is a flowchart illustrating an overview of an operation of the UE 100 according to an embodiment. In step S1 to step S5 of FIG. 6, the UE 100 is assumed to be in the RRC connected state.

In step S1, the UE 100 receives a multicast session (referred to as “multicast session #1”) from the network 5 (gNB 200) using a first MRB (multicast MRB) for the RRC connected state.

In step S2, the UE 100 receives, from the network 5 (gNB 200), an RRC Release message (i.e., RRC Release message including a suspend configuration) for causing the UE 100 to transition to the RRC inactive state. The RRC Release message includes configuration information (PTM configuration) indicating the configuration of a second MRB (multicast inactive MRB) used for receiving the multicast session #1 in the RRC inactive state. Note that the suspend configuration is an information clement indicating a configuration for the RRC inactive state.

In step S3, the UE 100 establishes the second MRB by applying the configuration information (PTM configuration) of step S2 before suspending the first MRB in response to the reception of the RRC Release message. Step S3 may be performed before applying the suspend configuration. Step S3 may be performed when applying the suspend configuration.

In step S4, the UE 100 starts receiving the multicast session #1 using the second MRB established in step S3. For example, the UE 100 starts receiving the second MRB (to be specific, the MTCH corresponding to the second MRB) immediately after applying the PTM configuration.

In step S5, the UE 100 suspends the first MRB. In particular, the UE 100 stops using the first MRB while maintaining the configuration of the first MRB. In this way, by suspending the first MRB after the second MRB is established, the multicast reception can be kept from being interrupted. Note that the UE 100 may suspend the first MRB after confirming that the reception of the multicast session #1 (that is, the reception of the MBS data) has been started via the second MRB. Such confirmation of the reception start (reception start success) may be performed in a lower layer (for example, the PDCP layer), and the RRC layer may be notified of the confirmation result. If the start of reception is not confirmed within a certain period of time, the UE 100 may determine that a reception error has occurred in the multicast session #1 or may suspend the first MRB thereafter. Upon detection of a reception error, the UE 100 may attempt to transition to the RRC connected state again (to be specific, transmit an RRC Resume Request).

In step S6, the UE 100 transitions from the RRC connected state to the RRC inactive state. The UE 100 in the RRC inactive state can continue receiving the multicast session #1 using the second MRB.

According to the operation, the multicast reception can be kept from being interrupted when the UE 100 in multicast reception in the RRC connected state transitions from the RRC connected state to the RRC inactive state.

### (3.2) Example of Operation Sequence

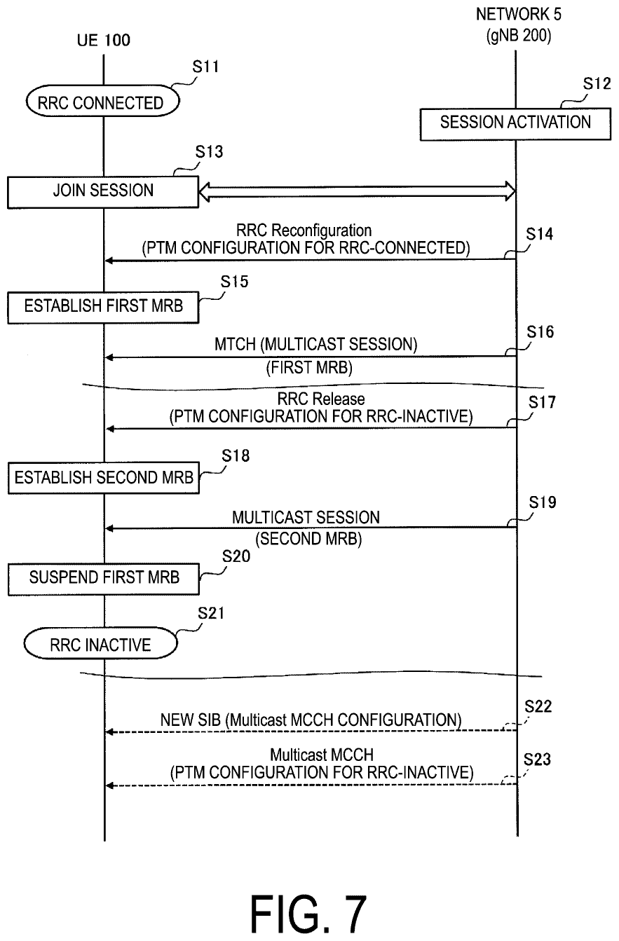

FIG. 7 is a flowchart illustrating an example of the sequence of an operation of the mobile communication system 1 according to an embodiment.

In step S11, the UE 100 is in the RRC connected state in a cell of the gNB 200.

In step S12, the network 5 activates a multicast session #1. Note that step S12 may be performed after step S13, after step S14, or after step S15.

In step S13, the UE 100 in the RRC connected state joins the multicast session #1.

In step S14, the gNB 200 transmits an RRC Reconfiguration message including the PTM configuration for RRC-connected to the UE 100. The UE 100 in the RRC connected state receives the RRC Reconfiguration message.

In step S15, the UE 100 in the RRC connected state applies the PTM configuration for RRC-connected of step S14 to establish a first MRB (multicast MRB) with the gNB 200.

In step S16, the gNB 200 transmits MBS data (multicast data) of the multicast session #1 to the UE 100 on the MTCH by using the first MRB. The UE 100 in the RRC connected state receives the multicast data.

Then, in step S17, the gNB 200 transmits an RRC Release message including a suspend configuration to the UE 100. The UE 100 in the RRC connected state receives the RRC Release message. The RRC Release message further includes a PTM configuration for RRC-inactive. The PTM configuration for RRC-inactive may be included in the suspend configuration. The PTM configuration may be an information element different from the suspend configuration.

In step S18, the UE 100 in the RRC connected state applies the PTM configuration for RRC-inactive of step S17 to establish a second MRB (multicast inactive MRB) with the gNB 200.

In step S19, the gNB 200 transmits MBS data (multicast data) of the multicast session #1 to the UE 100 on the MTCH by using the second MRB. The UE 100 in the RRC connected state receives the multicast data. At this point, the UE 100 may perform both multicast reception using the first MRB and multicast reception using the second MRB. Upon receiving the same multicast data in both the first MRB and the second MRB, the UE 100 may discard the multicast data of one side.

In step S20, the UE 100 in the RRC connected state suspends the first MRB.

In step S21, the UE 100 transitions from the RRC connected state to the RRC inactive state.

Thereafter, when the PTM configuration for RRC-inactive is likely to be updated, the UE 100 may receive a new SIB from the gNB 200 (step S22) and receive a multicast MCCH from the gNB 200 (step S23). Note that, although an example in which the RRC Release message includes the PTM configuration for RRC-inactive in step S17 has been described, while not limited thereto. In step S17, the UE 100 may receive the PTM configuration for RRC-inactive on the MCCH. The UE 100 may receive the RRC Release message (may not include the PTM configuration for RRC-inactive).

### (3.3) Specification Modification Example

In the following, a modification example of the 3GPP technical specification will be described. To be more specific, a modification example of TS38.331, which is the specifications of the RRC layer, will be described.

### (3.3.1) Specification Modification Example 1

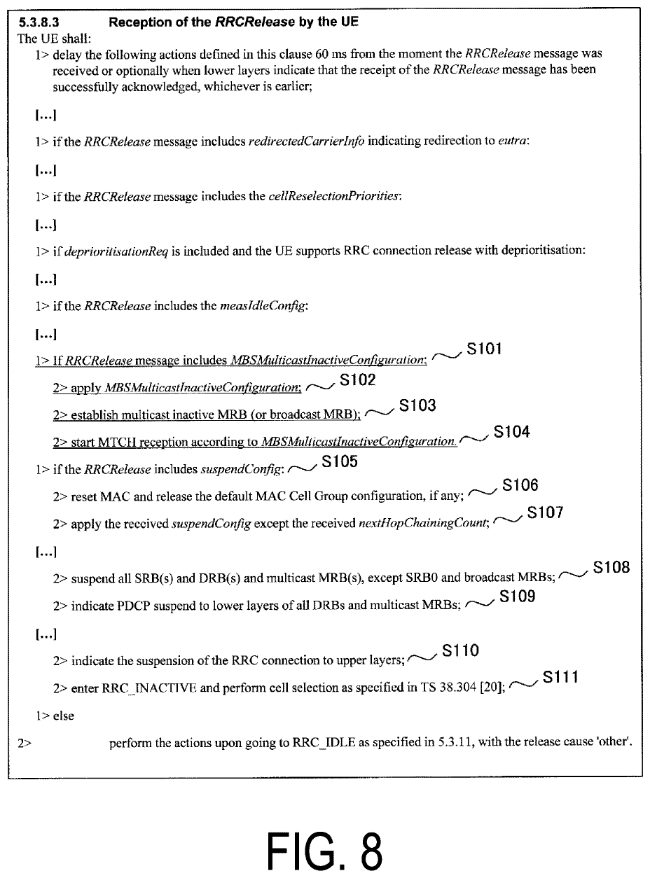

FIG. 8 is a diagram illustrating specification modification example 1 according to an embodiment. The operation shown in FIG. 8 is an operation performed by the UE 100 that has received an RRC Release message.

In step S101, the UE 100 checks whether the RRC Release message includes the PTM configuration for RRC-inactive (MBSMulticastInactiveConfiguration). If the RRC Release message includes the PTM configuration for RRC-inactive (MBSMulticastInactiveConfiguration), the UE 100 applies the PTM configuration for RRC-inactive (MBSMulticastInactiveConfiguration) in step S102. In step S103, the UE 100 establishes a second multicast inactive MRB (second MRB). In step S104, the UE 100 starts multicast reception (MTCH reception) using the second MRB.

Thereafter, in step S105, the UE 100 checks whether the RRC Release message includes a suspend configuration (suspendConfig). When the RRC Release message includes the suspend configuration (suspendConfig), the UE 100 resets the MAC in step S106. In step S107, the UE 100 applies the received suspend configuration (suspendConfig). The UE 100 suspends the first MRB in step S108 and step S109. The UE 100 does not suspend the second MRB. In step S110, the UE 100 indicates the suspension of the RRC connection to upper layers. Here, the UE 100 may notify the upper layers that the multicast session is receivable in the RRC inactive state (or the second MRB is not suspended). Alternatively, the UE may notify the upper layers of the session identifier (TMGI) of the multicast session. Finally, the UE 100 transitions to the RRC inactive state in step S111.

### (3.3.2) Specification Modification Example 2

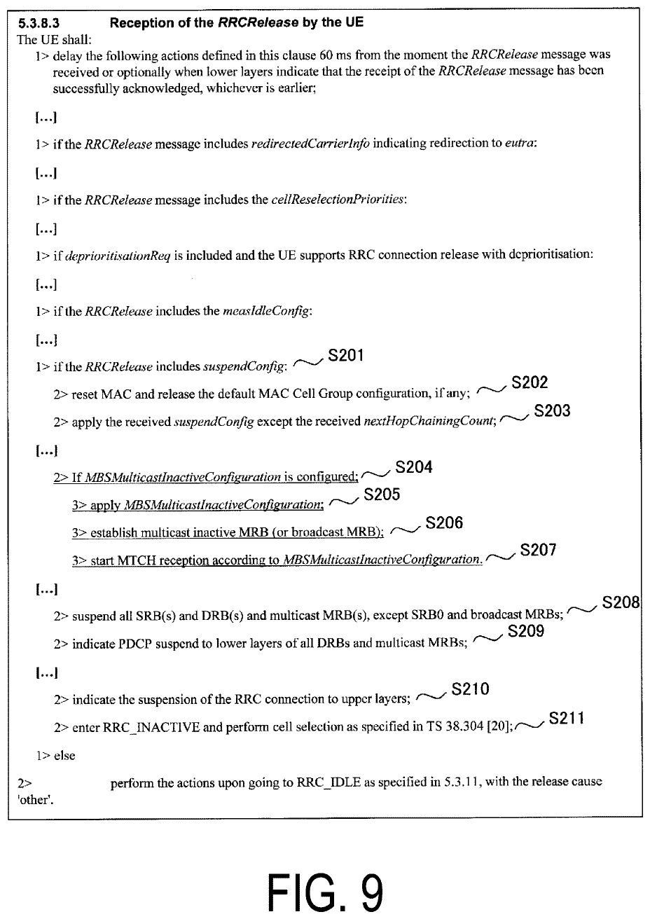

FIG. 9 is a diagram illustrating specification modification example 2 according to an embodiment. The operation shown in FIG. 9 is an operation performed by the UE 100 that has received an RRC Release message.

In step S201, the UE 100 checks whether the RRC Release message includes a suspend configuration (suspendConfig). When the RRC Release message includes the suspend configuration (suspendConfig), the UE 100 resets the MAC in step S202. In step S203, the UE 100 applies the received suspend configuration (suspendConfig). Here, in step S204, the UE 100 checks whether the PTM configuration for RRC-inactive (MBSMulticastInactiveConfiguration) has been configured in the suspend configuration (suspendConfig). If the PTM configuration for RRC-inactive (MBSMulticastInactiveConfiguration) is configured, the UE 100 applies the PTM configuration for RRC-inactive (MBSMulticastInactiveConfiguration) in step S205. In step S206, the UE 100 establishes a second multicast inactive MRB (second MRB). In step S207, the UE 100 starts multicast reception (MTCH reception) using the second MRB.

The UE 100 suspends the first MRB in step S208 and step S209. The UE 100 does not suspend the second MRB. In step S210, the UE 100 indicates the suspension of the RRC connection to upper layers. Here, the UE 100 may notify the upper layers that the multicast session is receivable in the RRC inactive state (or the second MRB is not suspended).

Alternatively, the UE may notify the upper layers of the session identifier (TMGI) of the multicast session. Finally, the UE 100 transitions to the RRC inactive state in step S211.

### (4) Other Embodiments

Although the multicast reception in the RRC inactive state has been mainly described in the above-described embodiments, the operations according to the above-described embodiments may also be applied to multicast reception in the RRC idle state. With respect to the RRC idle state, the above-described RRC resume (Resume) can be read as RRC establishment (Establishment).

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

Although the example in which the base station is an NR base station (gNB) has been described in the embodiments and examples described above, the base station may be an LTE base station (cNB) or a 6G base station. The base station may be a relay node such as an Integrated Access and Backhaul (IAB) node. The base station may be a DU of the IAB node. The UE 100 may be a Mobile Termination (MT) of the IAB node.

That is, the UE 100 may be a terminal function unit (a type of communication module) for a base station to control a repeater that performs signal relay. Such terminal function unit is referred to as an MT. Examples of the MT include, a Network Controlled Repeater (NCR)-MT, a Reconfigurable Intelligent Surface (RIS)-MT, in addition to the IAB-MT.

The term “network node” mainly means a base station, but may also mean a core network apparatus or a part (CU, DU, or RU) of the base station. The network node may include a combination of at least a part of the apparatus of the core network and at least a part of the base station.

A program causing a computer to execute each of the processing performed by the UE 100 or the gNB 200 may be provided. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 and the gNB 200 may be implemented as a semiconductor integrated circuit (chipset, System on a chip (SoC)).

The functions achieved by the UE 100 or the gNB 200 (the network node) may be implemented in a circuitry or a processing circuitry programmed to perform the described functions, including a general-purpose processor, a special-purpose processor, an integrated circuit, application specific integrated circuits (ASICs, a central processing unit (CPU)), a conventional circuit, and/or combinations thereof. The processor may include transistors and other circuits and may be considered a circuitry or a processing circuitry. The processor may be a programmed processor that executes a program stored in the memory. As used herein, a circuitry, a unit, means are hardware programmed to achieve, or hardware performing, the described functions. The hardware may be any hardware disclosed herein or any hardware programmed to achieve or known to perform the described functions. When the hardware is a processor that is considered to be a type of circuitry, the circuitry, means, or a unit is a combination of hardware and software used to configure the hardware and/or the processor.

The phrases “based on” and “depending on/in response to” used in the present disclosure do not mean “based only on” and “only depending on/in response to” unless specifically stated otherwise. The phrase “based on” means both “based only on” and “based at least in part on”. The phrase “depending on” means both “only depending on” and “at least partially depending on”. The terms “include,” “comprise” and variations thereof do not mean “include only items stated” but instead mean “may include only items stated” or “may include not only the items stated but also other items.” The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

The embodiments have been described above in detail with reference to the drawings, but specific configurations are not limited to those described above, and various design variations can be made without departing from the gist of the present disclosure.

### (5) Supplement A

Features relating to the embodiments described above are described below as supplements.

### (Supplement 1)

A communication method performed by a user equipment in a mobile communication system that provides a multicast/broadcast service (MBS), the communication method including: receiving a multicast session from a network in a radio resource control (RRC) connected state using a first multicast radio bearer (MRB) for the RRC connected state; receiving, from the network, an RRC release message for causing the user equipment to transition to an RRC inactive state, the RRC release message including configuration information indicating a configuration of a second MRB used for reception of the multicast session in the RRC inactive state; and establishing the second MRB by applying the configuration information before suspending the first MRB in response to the reception of the RRC release message.

### (Supplement 2)

The communication method described in Supplement 1, further including suspending the first MRB and transitioning to the RRC inactive state after the establishing the second MRB.

### (Supplement 3)

The communication method described in Supplement 1 or 2, further including starting reception of the multicast session using the established second MRB in the RRC connected state.

### (Supplement 4)

The communication method described in any one of Supplements 1 to 3, in which the RRC release message includes a suspend configuration indicating a configuration for the RRC inactive state, and the establishing the second MRB is performed before applying the suspend configuration.

### (Supplement 5)

The communication method described in any one of Supplements 1 to 4, in which the RRC release message includes a suspend configuration indicating a configuration for the RRC inactive state, the suspend configuration includes the configuration information, and the establishing the second MRB is performed when applying the suspend configuration.

### (Supplement 6)

A user equipment used in a mobile communication system that provides a multicast/broadcast service (MBS), the user equipment including a controller configured to perform processing of receiving a multicast session from a network in a radio resource control (RRC) connected state using a first multicast radio bearer (MRB) for the RRC connected state, processing of receiving, from the network, an RRC release message for causing the user equipment to transition to an RRC inactive state, the RRC release message including configuration information indicating a configuration of a second MRB used for reception of the multicast session in the RRC inactive state, and processing of establishing the second MRB by applying the configuration information before suspending the first MRB in response to the reception of the RRC release message.

### (6) Supplement B

### 1. Introduction

Work items about enhancement of the MBS (eMBS) are intended to support multicast reception by the UE in the inactive state and described as follows.
To define support for multicast reception by the UE in the RRC inactive state [RAN 2, RAN 3]
A PTM configuration for the UE that receives multicast in the RRC inactive state [RAN 2]
To investigate influences of mobility and state transitions of the UE that receives multicast in the RRC inactive state (seamless/lossless mobility is not required) [RAN 2, RAN 3]

RAN 2 has discussed this purpose and reached a series of agreements. Based on these agreements, the PTM configuration and mobility aspect for the multicast reception in the inactive state are discussed in this supplement.

### 2. Discussion

### 2.1 Initial Configuration Procedures

RAN2 #120 agreed to pursue “mixed approach”.

The mixed approach starts as follows:
1. When an NW configures a UE to continue multicast reception in the inactive state, the NW provides the PTM configuration for an activated multicast session to at least a serving cell through RRC dedicated signaling (other cases need to be further studied).
2. The MCCH is used when the PTM configuration needs to be changed or when the PTM configuration needs to be indicated during a transition beyond a serving cell/gNB. The change of the session status and other indications need to be further studied.
3. Assume that the UE can receive the multicast service after joining the session.
4. Whether the MCCH configuration is to be initially provided to the UE through dedicated signaling needs to be further studied.

RAN2 #121 has reached the following agreement.
Before receiving multicast in the RRC inactive state, the UE needs to join a multicast session.
The network may configure, when determined to be beneficial, the PTM configuration of the (one) serving cell for the UE before session activation to allow the UE to hold the configuration.
When the session is activated, the UE can receive a multicast session in the inactive state with the configuration applied, without returning to the RRC connected state, unless the session is updated by the MCCH after the configuration.
When the network configures the UE to receive multicast in the inactive state, the PTM configuration can be delivered by using an RRC release message containing suspendconfig. No other dedicated RRC message is used to provide the PTM configuration of MBS multicast in the inactive state.
A new MCCH logical channel for multicast the in inactive state is introduced (different from a broadcast MCCH).
A multicast MCCH configuration is provided via a new SIB.
As an option, the multicast MCCH configuration for the serving cell can also be provided in dedicated signaling. Therefore, the mobility is not optimized.

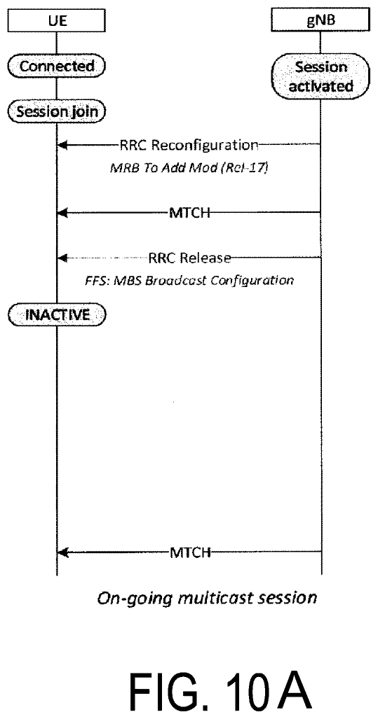

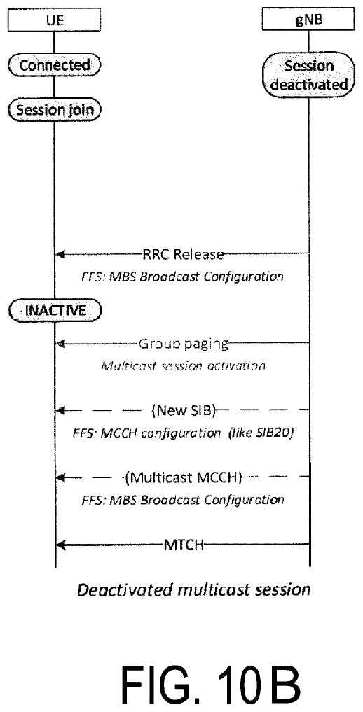

Based on these agreements, a configuration procedure of an ongoing (i.e., activated) multicast session and a configuration procedure of a deactivated (i.e., pre-activation) multicast session can be considered as shown in FIG. 10A and FIG. 10B.

### 2.1.1. Ongoing (Activated) Multicast Session

For an ongoing multicast session, the UE configures a multicast MRB for multicast reception in the connected state by an RRC reconfiguration and starts receiving the MTCH as in Rel-17. For multicast reception in the inactive state, the UE configures a broadcast MRB (or a new “multicast inactive MRB”) for multicast reception through RRC release.

For the PTM configuration of RRC Resume, it is clear that the content (i.e., IE) is the same, with Rel-17 MCCH (i.e., MBSBroadcastConfiguration) as the baseline. However, since RAN2 agreed to “Introduction of new MCCH logical channel”, the name of the RRC message also needs to be different from Rel-17 MBSBroadcastConfiguration. The same message is transferred via the new MCCH logical channel.
Proposal 1: RAN2 needs to agree to define a new RRC message for PTM configuration in RRC release and to define a new “multicast MCCH”, e.g., MBSMulticastInactiveConfiguration.
Proposal 2: RAN2 needs to agree that the IE of the new RRC message for PTM configuration is the same as Rel-17 MBSBroadcastConfiguration as baseline.

When the UE receives RRC release with suspendConfig attached as in Rel-17, the multicast MRB for the connected state is temporarily suspended. If the RRC Release includes the PTM configuration for the inactive state, the UE continues the same multicast session. Service continuity of the multicast session needs to be ensured during/after a transition of the RRC state. This is similar to legacy dedicated configurations such as redirectedCarrierInfo, cellReselectionPriorities, deprioritisationReq, and measIdleConfig. The UE needs to start receiving the broadcast MRB as soon as the PTM configuration is applied. Further study is needed with respect to whether a new procedure (i.e., the UE applies the PTM configuration and starts receiving the MTCH) is to be performed when the UE applies suspendConfig.
Proposal 3: RAN2 needs to agree that the UE needs to apply the PTM configuration of a multicast MRB (or a new “multicast inactive MRB”) and start receiving the corresponding MCCH before temporarily suspending the multicast MRB.

### 2.1.2. Deactivated (Pre-Activated) Multicast Session

In a deactivated multicast session, the UE performs PTM configuration by RRC release. If the above proposal 3 can be agreed, the UE immediately starts receiving the MTCH. However, the UE does not need to do so since no MTCH is transmitted at this time. Therefore, it is necessary to notify the UE that the multicast session is still inactive by using RRC release, so that the UE can wait for the activation notification of the multicast session without receiving the MTCH. The detailed operation needs to be further studied: for example, it can be decided whether to wait for the activation of the session while applying the PTM configuration.
Proposal 4: RAN2 needs to agree to inform the UE by using RRC release of whether the multicast session has been deactivated so that the UE does not attempt to receive the corresponding MTCH.

After transitioning to the inactive state, the UE monitors the multicast session activation notification (i.e., group paging). Before activation of a multicast session, the gNB may change the PTM configuration of the session, such change being configured by a new “multicast MCCH” of the UE in the inactive state. In this case, the gNB can transmit the “multicast MCCH” before the session activation.

From the perspective of the UE, if the UE needs to monitor a new “multicast MCCH” of the deactivated multicast session, power consumption of the UE increases. For this reason, it is necessary for the UE to confirm that the multicast MCCH does not need to be monitored before receiving the multicast session activation notification. In other words, the UE needs to monitor the multicast MCCH upon receiving the activation notification on the target TMGI. The same operation can be applied to a new SIB (such as SIB20) for MCCH configuration.
Proposal 5: RAN2 needs to agree that the UE does not need to monitor a new “multicast MCCH” or a new SIB (such as SIB20) when the corresponding multicast session is deactivated (i.e., before receiving the multicast session notification).

Upon receiving the multicast activation notification, the UE needs to check whether the MCCH configuration of the new SIB and/or the PTM configuration of the multicast MCCH has been updated if the MCCH configuration and/or the PTM configuration is provided via RRC release. As long as the configuration is not updated, a saved configuration (i.e. the configuration provided via RRC release) needs to be applied. Of course, if the configuration is updated, the UE needs to acquire a new SIB and/or multicast MCCH.

For a new SIB, it is expected that the UE can ascertain whether a new SIB has been updated by checking the value tag of SIB1, just as in the current state. On the other hand, the

UE cannot ascertain whether the multicast MCCH has been updated before receiving and decoding the MCCH. In this case, even if the configuration was made by using RRC release, the UE needs to decode the MCCH once, which is meaningless as well. In this sense, in order for the UE to ascertain the update of the PTM configuration without decoding the MCCH, the UE needs to introduce a value tag to the MCCH. A new SIB, SIB1, or group paging needs to be further studied with respect to where the value tag of the MCCH will be located.
Proposal 6: RAN2 needs to agree that the value tag of the MCCH, which the UE uses to ascertain whether the PTM configuration has been updated from the configuration by RRC release, is to be introduced, without decoding the MCCH itself.

### 2.2. Configuration Update in Inactive State

In Rel-17, there exists one MCCH per cell. In Rel-18, RAN2 has agreed the “introduction of a new MCCH logical channel for multicast in the inactive state (different from a broadcast MCCH)”. The multicast MCCH is used when the PTM configuration needs to be changed or when the PTM configuration needs to be indicated during a transition beyond a serving cell/gNB.
Observation 1: The multicast MCCH is used for updating the PTM configuration of the UE in the inactive state.

That is, there exist two MCCHs, which are a (broadcast) MCCH and a multicast MCCH, in the Rel-18 network. The motivation for introducing separate MCCHs in a cell is to handle different service requirements of different cast types (MBS broadcast and MBS multicast).

The question is whether different multicast sessions also have different service requirements. The service requirements for the group multimedia call service and the firmware download service are quite different. For example, because the group multimedia call service is a foreground service, a PTM configuration needs to be frequently optimized, but because the firmware download service is a background service, such frequent optimization is not required. Considering that the initial PTM configuration is provided through RRC release, updating of the PTM configuration on a multicast MCCH is necessary in some services but not for others. In this sense, introducing multiple multicast MCCHs is efficient for the UE and flexible for the network.
Proposal 7: RAN2 needs to discuss whether to introduce multiple multicast MCCHs per cell.

### 2.3. UE Mobility and Service Continuity

In RAN2 #120, using an MCCH for transitions of the UE has been agreed on.

A mixed approach begins as follows.
1. When the NW configures the UE to continue multicast reception in the inactive state, the NW provides the PTM configuration for an activated multicast session through RRC dedicated signaling to at least a serving cell (other cases need to be further studied).
2. The MCCH is used when the PTM configuration needs to be changed or when the PTM configuration needs to be indicated during a transition beyond a serving cell/gNB. The change of the session status and other indications need to be further studied.
3. Assume that the UE can receive the multicast service after joining the session.
4. Whether the MCCH configuration is initially provided to the UE through dedicated signaling needs to be further studied.

The WID states that seamless/lossless mobility is not required:
To define support for multicast reception by the UE in the RRC inactive state [RAN 2, RAN 3]
A PTM configuration for the UE that receives multicast in the RRC inactive state [RAN 2]
To investigate the influences of mobility and state transition of the UE receiving multicast in the RRC inactive state (seamless/lossless mobility is not required) [RAN 2, RAN 3].

RAN2 #120 concludes that a multicast MCCH is used to implement the PTM configuration in mobility.

The mixed approach begins as follows.
1. When the NW configures the UE to continue multicast reception in the inactive state, the NW provides the PTM configuration for an activated multicast session through RRC dedicated signaling to at least a serving cell (other cases need to be further studied).
2. The MCCH is used when the PTM configuration needs to be changed or when the PTM configuration needs to be indicated during a transition beyond a serving cell/gNB. The change of the session status and other indications need to be further studied.
3. Assume that the UE can receive the multicast service after joining the session.
4. Whether the MCCH configuration is initially provided to the UE through dedicated signaling needs to be further studied.

The above is similar to Rel-17 MBS broadcast. Therefore, it is natural to take the service continuity mechanism of Rel-17 MBS broadcast as a baseline. In this case, in the multicast session, it is necessary to first provide neighboring cell information from the MCCH and confirm that the UE has been permitted to prioritize the MBS frequency at the time of cell reselection.

As assumed in LTE SC-PTM and NRMBS broadcast, how to ensure service continuity, such as how to use neighboring cell information, whether to prioritize MBS frequencies, when/how to acquire an MCCH from neighboring cells, and the like, depends on the UE implementation.
Proposal 8: RAN2 needs to agree that neighboring cell information of a multicast session is provided from the MCCH in the same way as in MBS broadcast.
Proposal 9: RAN2 needs to agree that the UE prioritizes MBS multicast frequencies, similar to MBS broadcast, at the time of cell reselection.

In RAN2 #121, the area scope of the MCCH has been discussed. Some companies have proposed to enhance service continuity during UE transitions by enabling the PTM configuration in multiple cells. PTM configurations of respective cells can be easily aligned within gNBs (if necessary), but that is hard between gNBs, so negotiation with Xn-AP is necessary. Finally, RAN2 needs to agree that the area scope does not involve other gNBs and the area scope within gNBs needs further studies.

Serving cells do not provide the PTM configuration of the neighboring cells from other gNBs. Whether a network can provide the PTM configuration of cells within gNBs needs to be further studied.

It is thought that small-scale function enhancement limited to the scope of the gNB is not problematic. Therefore, RAN2 needs to discuss whether the PTM configuration can be applied to multiple cells in the gNB.
Proposal 10: RAN2 needs to discuss whether the PTM configuration can be applied to multiple cells in the gNB.

Another consideration is QoS control by the network. Although the WID does not require seamless/lossless mobility, not all multicast sessions that the UE is permitted to receive in the inactive state do not require seamless/lossless mobility. For example, although the network needs to cause the UE to transition to the inactive state due to congestion, the UE needs to be back to the connected state due to QoS requirements. For seamless/lossless mobility, Rel-17 MBS multicast supports handover in the RRC connected state. Therefore, it is necessary to study whether the network needs to have the option to control whether to let the UE perform cell reselection or resume the RRC connection before cell reselection (in case of handover in the connected state).
Proposal 11: RAN2 needs to discuss whether the gNB can indicate whether the UE is to be permitted to execute mobility in the inactive mode or needs to resume the RRC connection before cell reselection for better QoS control.

### REFERENCE SIGNS

1: Mobile communication system
5: Network
10: RAN
20: CN
100: User equipment (UE)
110: Receiver
120: Transmitter
130: Controller
200: gNB (Base station)
210: Transmitter
220: Receiver
230: Controller
240: Backhaul communicator

1. A communication method performed by a user equipment in a mobile communication system that provides a multicast/broadcast service (MBS), the communication method comprising:
receiving, from a network, a Radio Resource Control (RRC) release message for causing the user equipment to transition to an RRC inactive state, the RRC release message comprising configuration information that includes a Point-to-Multipoint (PTM) configuration used for receiving a multicast session in the RRC inactive state;
receiving the multicast session in the RRC inactive state in response to the RRC release message comprising the configuration information; and
in response to receiving the RRC release message, suspending use of a first data transmission bearer used in an RRC connected state, and establishing a second data transmission bearer, for use in the RRC inactive state, based on the configuration information.

2. The communication method according to claim 1, further comprising:
before receiving the RRC release message, receiving specific content data in the RRC connected state using the first data transmission bearer.

3. A user equipment for use in a mobile communication system that provides a multicast/broadcast service (MBS), the user equipment comprising:
a receiver configured to receive, from a network, a Radio Resource Control (RRC) release message for causing the user equipment to transition to an RRC inactive state, the RRC release message comprising configuration information that includes a Point-to-Multipoint (PTM) configuration used for receiving a multicast session in the RRC inactive state; and
a controller configured to, in response to receiving the RRC release message, suspend use of a first data transmission bearer used in an RRC connected state, and establish a second data transmission bearer, for use in the RRC inactive state, based on the configuration information,
wherein the receiver is further configured to receive the multicast session in the RRC inactive state in response to the RRC release message comprising the configuration information.

4. A non-transitory computer-readable medium storing instructions that, when executed by a processor of a user equipment, cause the user equipment to perform the steps of:
receiving, from a network, a Radio Resource Control (RRC) release message for causing the user equipment to transition to an RRC inactive state, the RRC release message comprising configuration information that includes a Point-to-Multipoint (PTM) configuration used for receiving a multicast session in the RRC inactive state;
receiving the multicast session in the RRC inactive state in response to the RRC release message comprising the configuration information; and
in response to receiving the RRC release message, suspending use of a first data transmission bearer used in an RRC connected state, and establishing a second data transmission bearer, for use in the RRC inactive state, based on the configuration information.

5. A chipset for a user equipment for use in a mobile communication system that provides a multicast/broadcast service (MBS), the chipset configured to execute the instructions stored on the non-transitory computer-readable medium of claim 4.

6. A system for use in a mobile communication system that provides a multicast/broadcast service (MBS), the system comprising:
the user equipment according to claim 3; and
a base station comprising a transmitter configured to transmit the RRC release message comprising the configuration information and the multicast session to the user equipment.
